(19) United States
(12) Patent Application Publication
(10) Pub. No.: US 2002/0131608 A1
(43) Pub. Date: Sep. 19, 2002

(54) Method and system for providing digitally focused sound

(76) Inventors: William Lobb, Wallingford, CT (US); Lynn Mader, Bismarck, ND (US)

Correspondence Address: MORGAN & FINNEGAN, L.L.P., 345 Park Avenue, New York, NY, 10154, US

(21) Appl. No.: 09/797,532

(22) Filed: Mar. 1, 2001

(51) Int. Cl. H04R 3/00

(52) U.S. Cl. 381/111

(57) ABSTRACT

A sound system comprising a planar array of at least two sound producing elements and a digital control for controlling the focus of the array. Each element in the array is fed the same signal, but delayed in time according to each element's position in the array. Proper selection of time delays result in the audible signal from each element in the array arriving at a given target area coincidentally and coherently, whereas at any other location the signal does not arrive coincidentally, so that, at all but the target area, the sound signals are incoherent and do not add up to the volume that is achieved in the target area. The arrangement of sound elements in a flat planar array allows for the speaker system to be more easily concealed in a floor, wall or ceiling, as well as suspended from above.

### FIELD OF THE INVENTION

The present invention relates generally to sound systems, and more specifically, to a system and method for controlling the spatial effect produced by the sound system.

### BACKGROUND OF THE INVENTION

In contemporary museums and exhibit spaces, where there is a growing trend for exhibits to be active or interactive, there is often a projected motion picture or video display with an accompanying audio soundtrack. It has long been sought to confine the sound from the soundtrack to the immediate vicinity of a particular exhibit (e.g., display) so as to keep sound from one exhibit from spreading to and interfering with adjacent exhibits which are usually playing completely different soundtracks. To further complicate matters, typical museums often have hard (e.g., marble) floors and walls which effectively reflect sound throughout the museum, causing interference with other exhibits.

Prior art solutions have included physical devices to isolate exhibits (with respect to their individual soundtracks) by directing transmitted sound through, for example, use of a long tube or a reflective dome.

In the case of the long tube, the inner wall of the tube is typically lined with a sound absorbing material. A tube is suspended over the exhibit area and a loudspeaker is placed at the far end of the tube. The tube guides sound emanating from the loudspeaker to the exhibit area. The tube, however, does not focus sound but only prevents it from spreading.

In the case of the reflective dome, a reflecting plastic hemisphere or parabola that focuses the sound in the same manner that an auto headlamp focuses light facing the hemisphere or parabola is suspended over the exhibit area and a loudspeaker is located at a focal point of the hemisphere or parabola. Sound produced by the loudspeaker is collected by the dome and focused in a narrow beam toward the exhibit area.

Visually, these devices are often considered objectionable by architects and exhibit designers. They are visually distracting by virtue of their appearance and their often being difficult to conceal due to their size. In the case of the tube, to be effective, the tube must be at least several feet long with a diameter of twelve inches or more in order to accommodate a typical loudspeaker. Similarly, the dome has cumbersome physical requirements for it to be effective. Generally the dome will have a diameter of at least thirty inches and a depth of at least twelve inches to be effective for such applications. In either case, because of the large and bulky physical required attributes of the devices, deployment in exhibits of limited area can be difficult, if not unfeasible.

Sound quality is another issue that limits the usefulness of these devices. Long narrow tubes are inherently resonant, exaggerating some audible frequencies and suppressing others. In the case of the dome, there is only room for a few small loudspeakers clustered near the focal point resulting in limited frequency response.

Other known systems use controlled directivity to effect limited levels of sound focusing. For example, U.S. Pat. No. 6,128,395 to De Vries entitled “Loudspeaker system with controlled directional sensitivity” deploys various loudspeakers arranged in predetermined patterns and having associated digital filters and delay such that, during operation, a sound pattern of a predetermined form and directivity can be generated by manipulation of the filter and delay characteristics. The loudspeakers in such a system have a mutual spacing which substantially corresponds to a logarithmic distribution, wherein the minimum spacing is determined by the physical dimensions of the loudspeakers used.

Implementation of this type of system typically provides loudspeakers in a one dimensional planar arrangement—i.e., as a speaker column or array. The typical sound distribution pattern of such a system can be described as being a disc perpendicular to the plane of the array or column. For example, a known implementation of such a system arranges a plurality of large (e.g., 8 inch) speakers in a vertical logarithmic distribution in a one dimensional array possibly 15 feet above the ground. The sound concentration is configured so as to project a wide area disc (typically on the order of meters wide at about 5-6 feet above the ground). Such systems are useful in public address systems for example in large areas such as a train station terminal. Two dimensional arrays are also known. For example, when multiple arrays are arranged parallel to each other, the sound distribution will be a variant of the wide area disc proportional to the predetermined spatial coherence of the configuration. Where two arrays are arranged so as to be perpendicular to each other, the resultant distribution will exhibit larger sound intensity (or coherence) at an intersection of the 2 respective resultant sound discs which are normal to each other.

### SUMMARY AND OBJECTS OF THE INVENTION

The foregoing and other problems and deficiencies in focused sound systems are solved and a technical advance is achieved by the present invention for a digitally focused array of sound producing elements.

It is an object of this invention to provide improved sound focus and directivity control as is not available with known systems and more particularly to preferably provide tight-focused sound from a planar array of sound producing elements.

In order to provide a more effective and aesthetically pleasing device, in one embodiment, a plurality of sound producing elements are placed in a flat planar array. Each element in the array is fed the same signal delayed in time according to each element's physical position in the array. By proper selection of time delays, the audible signal from each element in the array is caused to arrive at any given target area coincidentally.

Under one embodiment of the present invention, identical sound producing elements are placed in a rectangular planar array, but other arrangements are equally effective in alternative embodiments. For example, the elements can be arranged in a line, in concentric circles, or randomly, in a flat or curved (i.e., non-flat) array. Regardless of physical configuration, the audible signal from each element must arrive at the target area at substantially the same time.

By manipulating the various delays, the target area can be positioned at any location forward of the plane of the array. The target area can also be widened to cover a larger area, although that of course would reduce the gain accordingly. Also, the array can be divided into two or more channels for a stereo effect. Through fine control of the signal delay many useful variations can be achieved.

Control of the signal delay is achieved with a digital bit stream that represents the desired analog audio signal. To achieve the desired delay, in one embodiment, the bit stream is passed through several shift registers that progressively delay the signal according to the requirements for the various individual elements, which in practice can range from a few microseconds up to several hundred microseconds. The bit stream, after proper delay, is passed directly to the sound producing elements (or transducers) without conversion to an analog signal. The transducers themselves convert the bit stream to a properly delayed audible signal.

### BRIEF DESCRIPTION OF THE DRAWINGS

The foregoing and other features and advantages of the present invention will become more apparent in light of the following detailed description of exemplary embodiments thereof, as illustrated in the accompanying drawings, where:

FIG. 1 is an isometric drawing of an illustrative embodiment of an array of sound producing elements according to the present invention.

FIG. 2A is an illustration of an application of one embodiment according to the present invention.

FIG. 2B is a block diagram of an offset target arrangement according to an illustrative embodiment of the present invention.

FIGS. 3A and 3B are block diagrams of a preferred embodiment of the system of the present invention.

FIG. 4 is an isometric drawing of a portion of the array of FIG. 1.

FIG. 5 is an isometric drawing of a portion of the array of FIG. 1.

FIG. 6 is a block diagram of a digital implementation according to an illustrative embodiment of the present invention.

FIGS. 7A-7D are block diagrams of alternative illustrative implementations of memory control of the digital implementation of FIG. 6.

FIG. 8 is a schematic drawing of a driver for a sound-producing element of the array according to an illustrative preferred embodiment of the present invention.

### DETAILED DESCRIPTION OF THE DRAWINGS

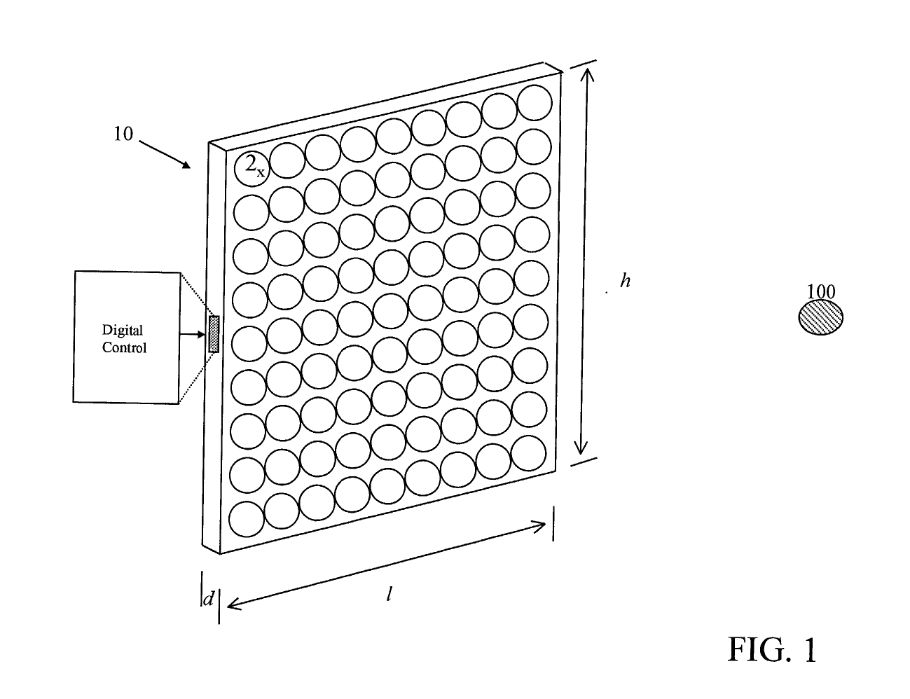

In order to provide a more effective and aesthetically pleasing device, in one embodiment, a plurality of sound producing elements 2ₓ (where x is an integer corresponding to the number of elements deployed in the array) are located in a flat planar array 10 as shown in FIG. 1. Although the planar array can have any height, depth and length dimensions (h×l×d), in a preferred embodiment, sound producing elements 2ₓ are placed in a rectangular planar array that is 36″×36″×2″. Such an array configuration is advantageous for reasons which will become apparent in light of the description contained herein with respect to attainable sound level at a focus area 100. From a practical standpoint, an array of such dimension and configuration can be more easily concealed in a floor, wall, or ceiling, as well as suspended from above making it more aesthetically acceptable for use in applications where visual distraction is preferably minimized (e.g., museum exhibits).

In the illustrative embodiment shown in FIG. 1, 81 identical sound producing elements (or “transducers”) are deployed in a rectangular array (i.e., x=81). It will be appreciated that other quantities and arrangements of elements are equally effective to implement the present invention as well as non-identical transducers as will be understood by one of skill in the art. For example, alternative embodiments can deploy the elements arranged in a line, in concentric circles, or randomly and the configuration can be symmetrical or not. The exact physical arrangement (i.e., physical placement) of the elements is not critical, as will be explained in detail infra. Under the present invention, it is important that the audible signal from each element arrive at a target area 100 at the same time—i.e., that the individual sound sources (i.e., from each element) are coherent at the desired target area. The target area can be either a tight focus area or a standard focus area. In a tight focus area, the diameter is typically on the order of 8 inches (e.g., the representative average of a head width of an individual observing the attendant exhibit). In a standard focus application, the width of the target is larger, possibly on the order of 24 inches. In the illustrative embodiment, the target area is a tight focus area.

When the sound sources are coherent at the target area 100, that is, of equal phase and amplitude at area 100, they superpose as 20 log n; where n is the number of sources, which, in this illustrative embodiment, is 81. Conversely, when the sources are incoherent, they superpose as 10 log n. The resulting gain in decibels at the target location will therefor be understood as: (20 log n)−(10 log n)=10 log n. It is seen, then, that the gain will depend upon the number of elements in the array. That is, the more the better. For example, a ten by ten array of one hundred elements will have a gain of (10×2)−3=17 decibels whereas a four by four array will have a gain of (10×1.2)−3=9 db.

In practice the actual gain is: (10 log n)−3 because usually, in the zone of incoherence, by random chance two elements can be found that are coherent. They will, however, only be coherent with each other but not with any other coherent pairs that can be found, due to the time delays which tend to favor coherency only at the target location. The general rule of (10 log n)−3 has been verified by measurement using practical arrays.

Under the teachings of the present invention, coherence at a target area is achieved by manipulating various delays implemented for each sound source (i.e., element or transducer). By such manipulation, the target area 100 can be positioned at and/or moved to any location forward of the plane of the array. The target area can also be widened to cover a larger area, although this would reduce the gain accordingly. As previously mentioned, in the preferred embodiment, a tight focus target area is achieved.

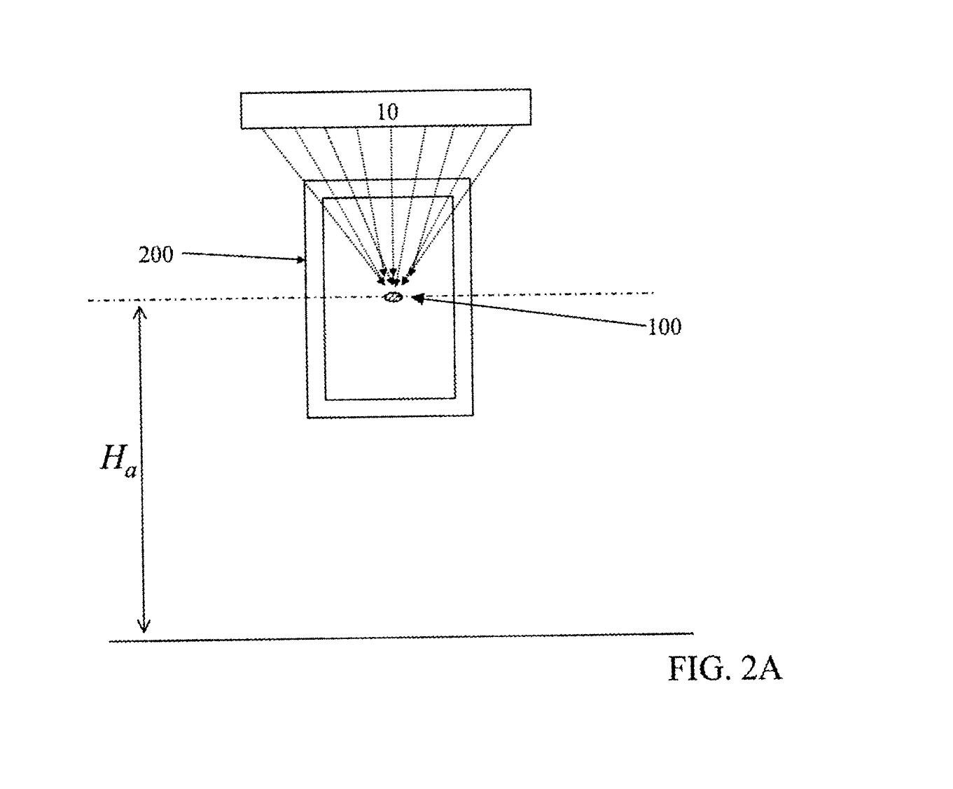

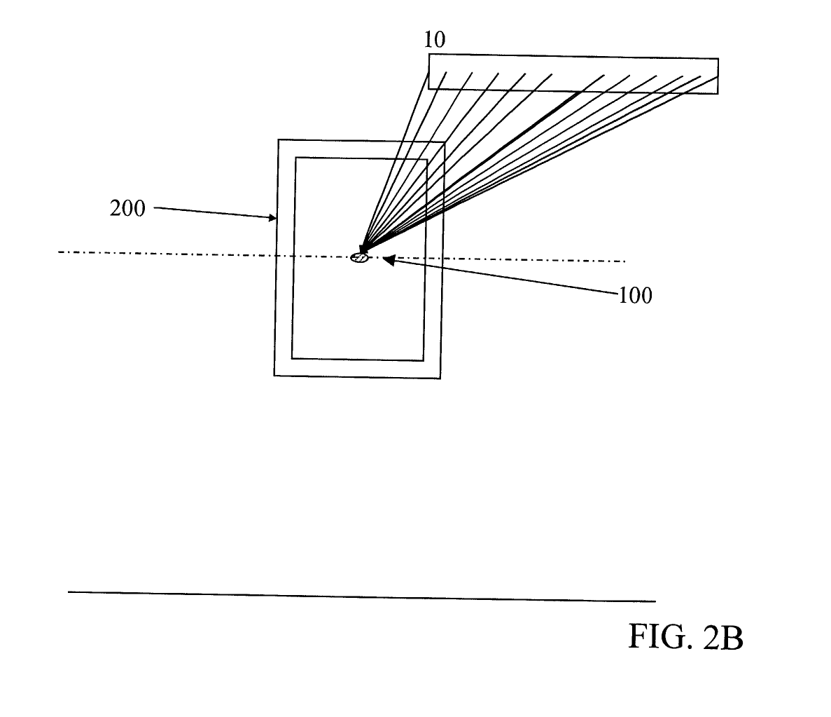

An illustrative application is shown in FIG. 2A, where the array 10 is suspended above an exhibit 200. The target area 100 can, for example, be chosen to be at an average height Hₐ of an individual viewing the exhibit (e.g., 5 to 6 feet).

Accordingly, with respect to the array configuration described supra, as physical placement or distribution of the individual elements is not critical, it is only necessary to know where the individual elements are located (relative to the target area) so that proper signal delays (as will be explained) can be effected to achieve the desired convergence (i.e., at area 100).

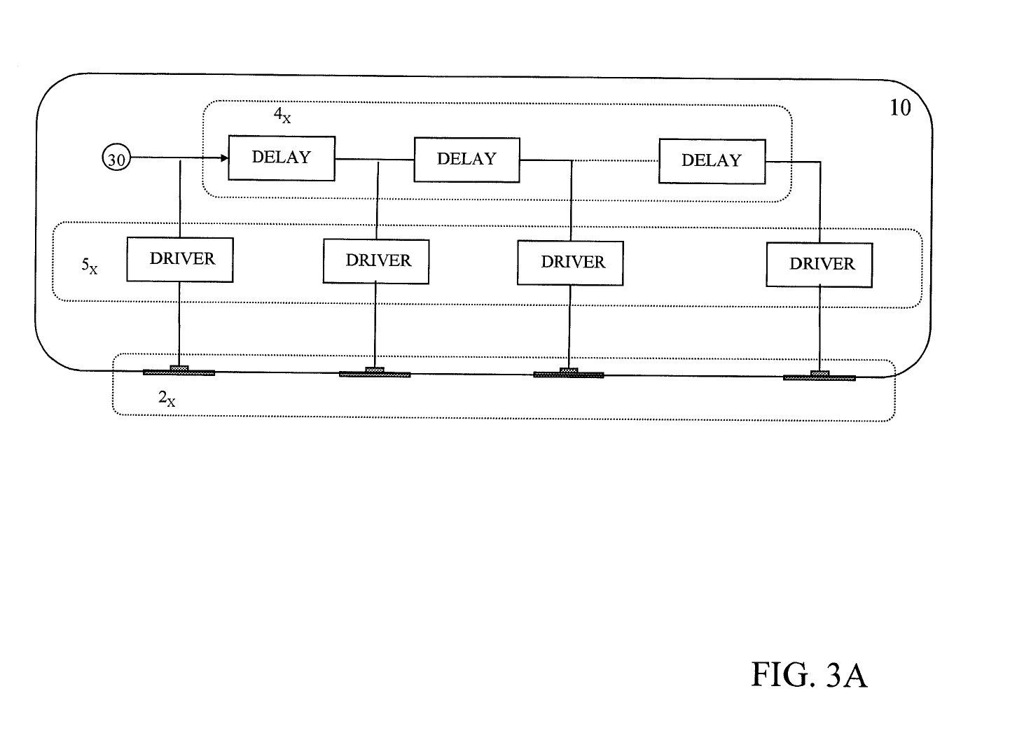

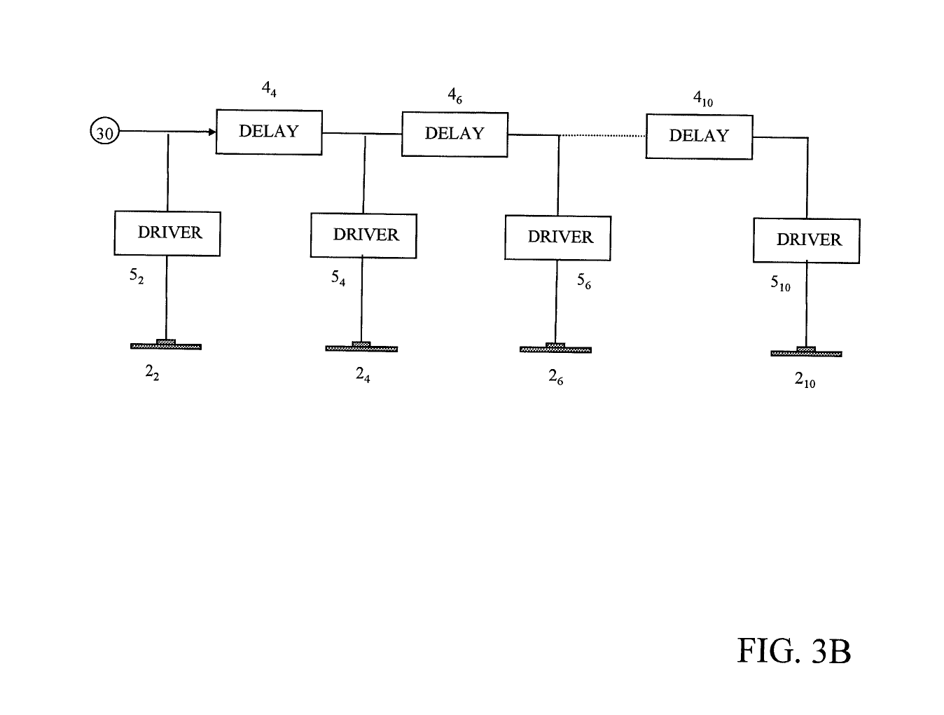

FIGS. 3A and 3B illustrate block diagrams of the preferred embodiment according to the present invention wherein an audio signal is input at 30. As shown in FIG. 3A, a single array input 30 is used for all the elements of the array. Signal 30 is delayed in time by a pre-determined amount according to each element's physical position in the array via respective delay 4ₓ. By proper selection of time delays according to the teachings of the present invention, the audible signal from each element in the array is caused to arrive at any given target area 100 (FIG. 1) coincidentally, whereas at any location other than target 100, the signal does not arrive coincidentally. That is, properly selected delays will cause coherence only at target area 100 and everywhere but at the target area the sound signals are incoherent and do not add up to the volume achieved at the target area. The delayed signal is then used to drive the respective element or transducer 2ₓ via respective driver 5ₓ.

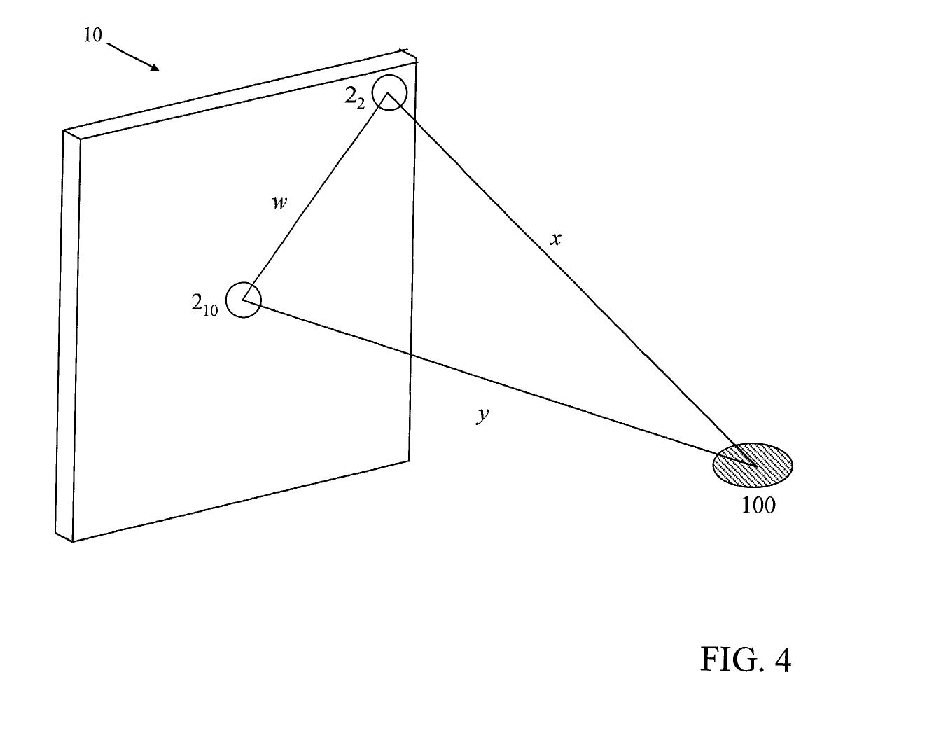

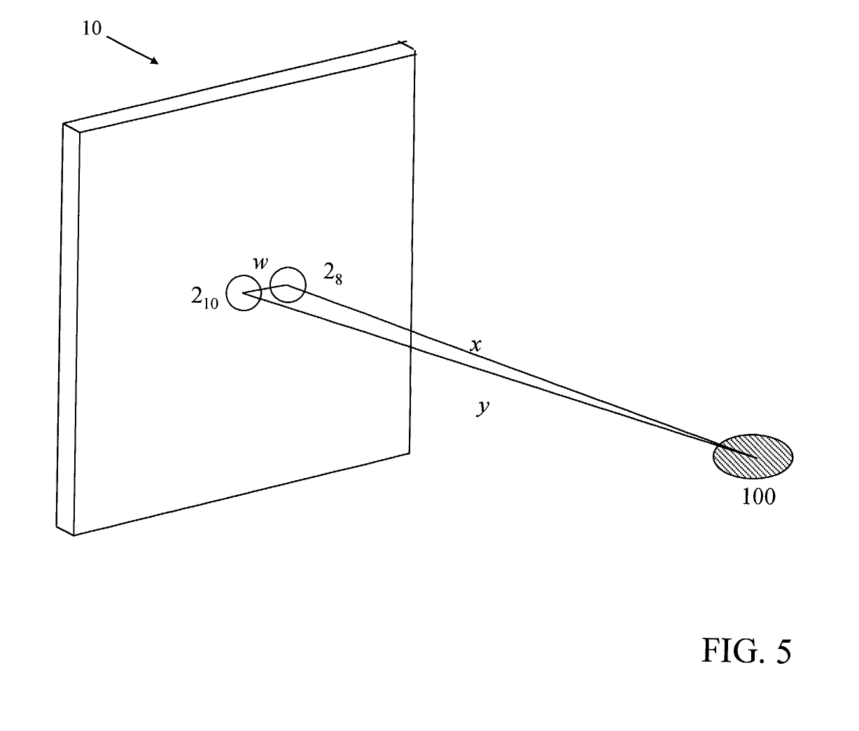

In the embodiment as illustrated in FIG. 3B, signal 30 is passed, undelayed to driver 5₂ which drives sound-producing element 2₂. (N.B.: A delay can be used to drive this element as well if desired.) Element 2₂ is that element of the array that is farthest from the target area 100 (See FIG. 4). Signal 30 is also fed to delay 4₄ which delays the signal and similarly passes it to driver 5₄ to drive sound producing element 2₄ and delay 5₆. Element 2₆ of the array is that which is next nearest the target location. The signal continues on in like manner until reaching element 2₁₀ which is nearest to the target location (the center element in the illustrative embodiment). (See FIGS. 4 and 5, infra.) As will be understood, delays for subsequent drivers are cumulatively implemented.

In FIG. 4, the nearest (or center in the illustrated embodiment) element 2₁₀ and the farthest element 2₂ from the target are shown. It is assumed, for purposes of the illustrative calculation which follows, that target area 100 is centered on the array (i.e., that target 100 is coaxial to the center element in an axis perpendicular to the plane of the array). As discussed supra, under the present invention, it is desired to delay the signal driving element 2₁₀ so that the sound generated by element 2₁₀ arrives at target area 100 coincidentally with the sound from element 2₂ which must travel a longer distance to arrive at target 100. In other words, coherence is achieved at target 100 by delaying the sound signal generated from sources (i.e., elements or transducers) in the array in proportion to their linear proximity to the target so that those elements closest to the target are delayed sufficiently to ensure their arrival at the target at the same time as those elements situated farther from the target.

For representative elements 2₂ and 2₁₀, also shown in FIG. 4 are representative distance vectors w, x, and y. In practical application, vector y is known (i.e., it can be measured or is specified). Vector w is also known (i.e., again either measured or specified). Vector x can be found through simple calculation using the Pythagorean Theorem which, in this case, specifies that: w²=x²+y² or w=\sqrt{x²+y²}. The distance difference between vector x and vector y, Δd, can be derived from: Δd=\sqrt{x²+y²}−y The required delay, Δt, for element 2₁₀ is derived from: Δt=v_{c}(\sqrt{x²+y²}−y), where vₛ is the velocity of sound.

In a sample calculation, assuming vₛ in air to be 74 microseconds per inch, vector x to be 60 inches and vector w to be 24 inches, the required delay for element 2₁₀ (with respect to element 2₂) would be 74(\sqrt{24²+60²}−60)=342 microseconds.

In FIG. 5, the calculation is repeated for nearest (i.e., the center element) element 2₁₀ and the next nearest element 2₈ to the target. Assume vector w to have a practical value of 4 inches in this illustrative embodiment. By similar calculation as in the previous example, the required delay, to the nearest microsecond, is calculated as follows. For element 2₈ (with respect to element 2₁₀) the distance delta Δd requires a delay of 74(\sqrt{4²+60²}−60)=10 microseconds. That is, since element 2₈ is 10 microseconds farther away from target 100 than element 2₁₀, the delay implemented for element 2₈ with respect to element 2₂ will be 10 microseconds less than the delay for element 2₁₀, or 332 microseconds.

As mentioned supra with respect to FIGS. 3A and 3B, the delays for subsequent drivers (and consequently elements) are cumulative. As just shown in the sample calculation, the required delay for element 2₈ is 332 microseconds and that of element 2₁₀ is 342 microseconds. Therefore the delay 5₁₀ only needs to further delay the driving signal of element 2₈, which is already delayed by 332 microseconds (cumulatively or individually), by an additional 10 microseconds to arrive at the required delay of 342 microseconds for element 2₁₀ (with respect to element 2₂).

The correct delay for each element of the array is similarly calculated. It will often be found that two or more elements will require the same delay due to symmetry of element layout (e.g., their Δd is the same). While the delay for such elements can none-the-less be implemented individually as in the illustrative embodiment, alternatively, in the interest of economy, such elements may be connected together and, e.g., share a common delay point and/or a common driver to reduce the number of required components.

Where the array is configured so that there is no center element (e.g., in a concentric array arrangement or where an even number of elements is deployed in a square array, e.g., 8×8) or where the target area is not centered on the array—i.e., it is an “offset” target (see example FIG. 2B), it will be understood from the teachings herein that the invention may be practiced by measuring the linear distance from each element in the array to the target area. The difference between the various measured distances (i.e., Δd) is calculated (as shown above with respect to FIGS. 4 and 5) to determine the respective delays of the individual elements. Typically it is determined which element in the array is nearest to the target area and Δd is calculated relative to this element, with the delays for the respective elements derived and implemented accordingly as discussed supra. In the case of offset targets, the necessary geometries as discussed in the above described illustrative centered target example will be understood from known geometric principles.

The foregoing discussion shows an array with a single audio input 30. As will be understood, in alternative embodiments the array can be configured to achieve a stereo effect. For example, stereo effect can be implemented by two inputs where one audio signal is used for each of a left or right channel. Two A/D converters—one for each of the left or right channel and two memory chains—one for each of the left or right channel would also be used. The sound producing elements in the array would then be designated as being left or right channel and are connected accordingly to the respective input, A/D converter and memory chain. In the illustrative embodiment, the elements left of the target area would be assigned, e.g., to the left channel and those right of the target area to the right channel, each channel driven by the input assigned to the respective channel. In such an embodiment, the target area would be effectively “split” into 2 areas—one target area for the right channel and one for the left. The individual foci of the left and right channels would be directed to fall, for instance, 7-8 inches apart as that is an average distance between the ears of an individual listening at the target area.

In alternative embodiments, it will be understood by one of skill in the art that the present invention can be adapted to effect more than one focal point from a single array, where, for example, multiple target areas can be achieved under the teachings of the present invention by, for example, using additional sets of delays, which will allow for coherence at more than a single target area with “dead zones” in between the target areas so that people standing at the particular target areas will hear the soundtrack while people standing in the dead zone areas will hear little or no sound.

As will also be understood it is possible in variant embodiments to have more than one program in an array each focused on a different area by, e.g., using multiple soundtracks each as a separate audio signal input and multiple sets of delays, each set corresponding to each soundtrack and desired target area so that e.g., people standing in the various target areas can hear different soundtracks.

Under the present invention, through fine control of the signal delay many variations in sound focus and directivity can thus be achieved. Fine control of the signal delay is achieved, for example, with a digital bit stream that represents the analog audio signal. In an illustrative embodiment, the bit stream is passed through several inexpensive shift registers that progressively delay the signal according to the requirements for the various elements, which in practice can range from a few microseconds up to several hundred microseconds. The bit stream, after proper delay, is passed directly to the sound transducers without conversion to an analog signal. The transducers themselves convert the bit stream to a properly delayed audible signal.

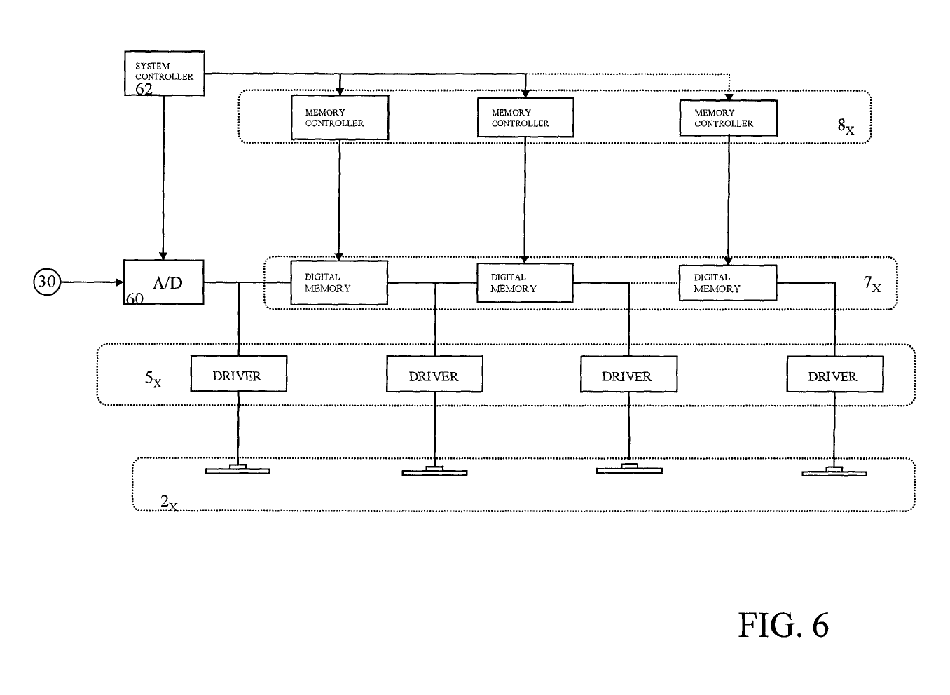

FIG. 6 is a block diagram showing one embodiment for providing the required delay to the individual elements of the array. The audio signal is input at 30 and immediately sampled by an analog to digital converter 60. In the preferred embodiment, a serial digital stream is used to drive the sound producing element, thus the A/D converter used is of the one-bit delta modulation type. This A/D will output a serial bit (digital) stream with a value of digital one if the signal amplitude is rising or digital zero if the signal amplitude is falling. If the signal is neither rising nor falling (such as when the audio signal is silent), the converter outputs alternate ones and zeros. In alternative embodiments, other converters may be used to form the digital bit stream including, e.g., pulse width modulation type converters.

The digital bit stream is stepped sequentially though a series of shift registers constituting digital memory 7ₓ under a clock in the system controller 62. Thus, for each sample taken by the converter 60, the previous samples are advanced one stage through memory. The delay of the bit stream at any stage in memory will depend on the number of previous stages and upon the clock rate. A preferred clock rate is one megahertz (1 mHz), which provides adequate sampling of the audio signal and a resolution in memory of one microsecond. Other clock rates, as will be understood by those skilled in the art, may be utilized as different situations warrant or for different desired effects.

Memory controllers 8ₓ set the number of active stages in memory according to the delay requirements of the individual elements in the array.

In various embodiments, memory control can be implemented in alternative manners.

In one alternative embodiment, the memory control is hardwired to provide a fixed focus. This is usually performed when the array is manufactured according to design specifications and is unalterable in the field. In this case, the system and memory controller provides the clock signal only to the digital memory.

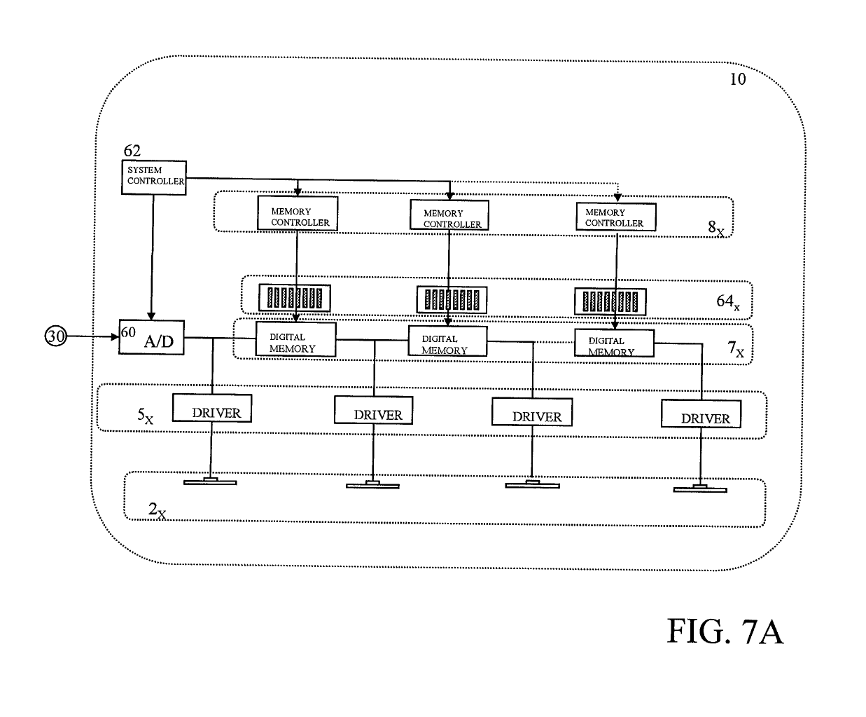

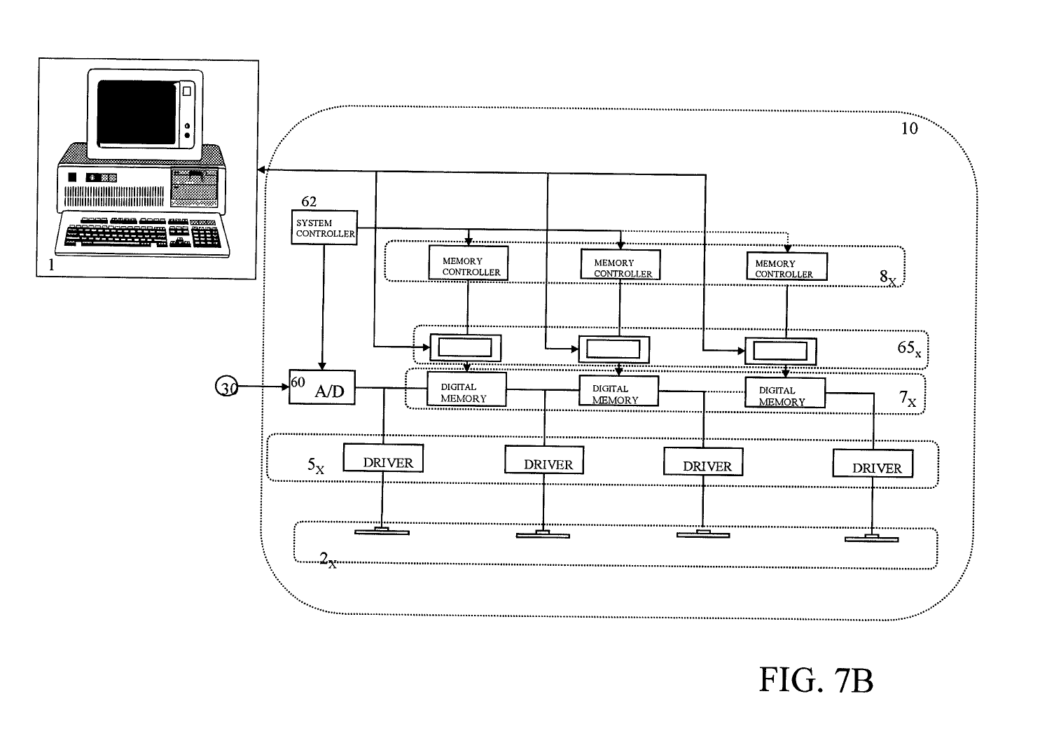

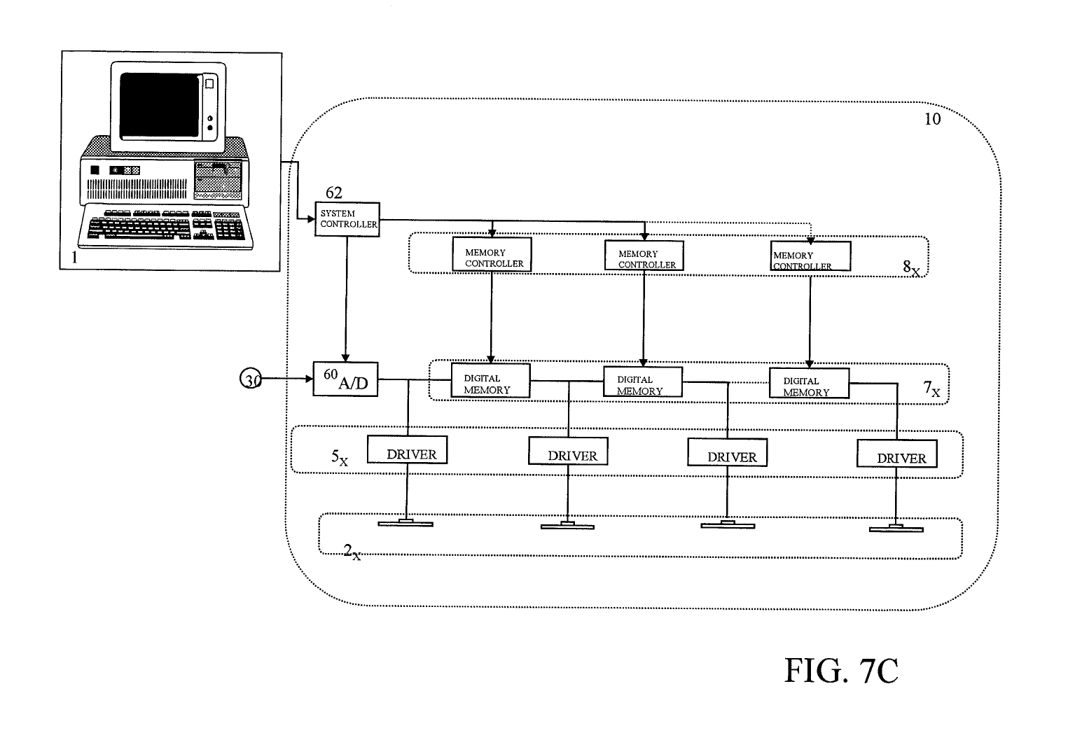

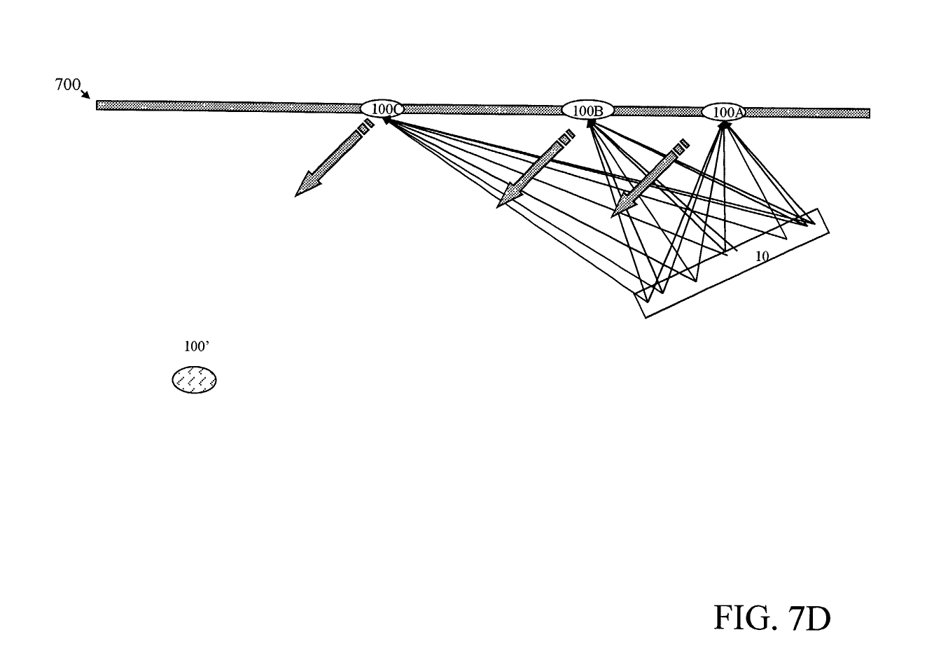

Alternatively, as shown in FIG. 7A, the memory control is implemented via DIP switches 64ₓ provided at the digital memory. This offers the advantage over the hardwired embodiment of being field settable and gives a degree of flexibility in determining the focus of the array. Again, in this case the system and memory controller would provide only the clock signal to the digital memory.

In other alternative embodiments as shown in FIGS. 7B and 7C, memory control can be directed by an externally connected computer 1 (e.g., a PC via a USB or RS232 interface as is known) to enable changes to the focus. The computer can either be connected temporarily to program in the field, for example, an EPROM 65ₓ which will perform a function similar to the DIP switch or hardwire to control memory (FIG. 7B), or the computer can be connected indefinitely (FIG. 7C) to enable, e.g., continuous changes to the focus to implement, for example, dynamic panning of the focus for motion sound effects. In this case, the system and memory controller (under the control of the PC) generates a delay word and clock which are fed to the digital memories to effect the desired delays.

As a further extension of the embodiment shown in FIG. 7C, to provide more complex motion and spatial effects, an acoustically reflective panel 700 can be deployed in conjunction with dynamic panning of the focus of the array 10 as illustrated in FIG. 7D. By panning the focus to fall along the, e.g., longitudinal axis of the acoustically reflective panel 700, at points 100A, 100B, 100C etc, a motion effect can be perceived at a predetermined target area 100′. Other spatial and motion effects are also possible as will be appreciated by one of skill in the art.

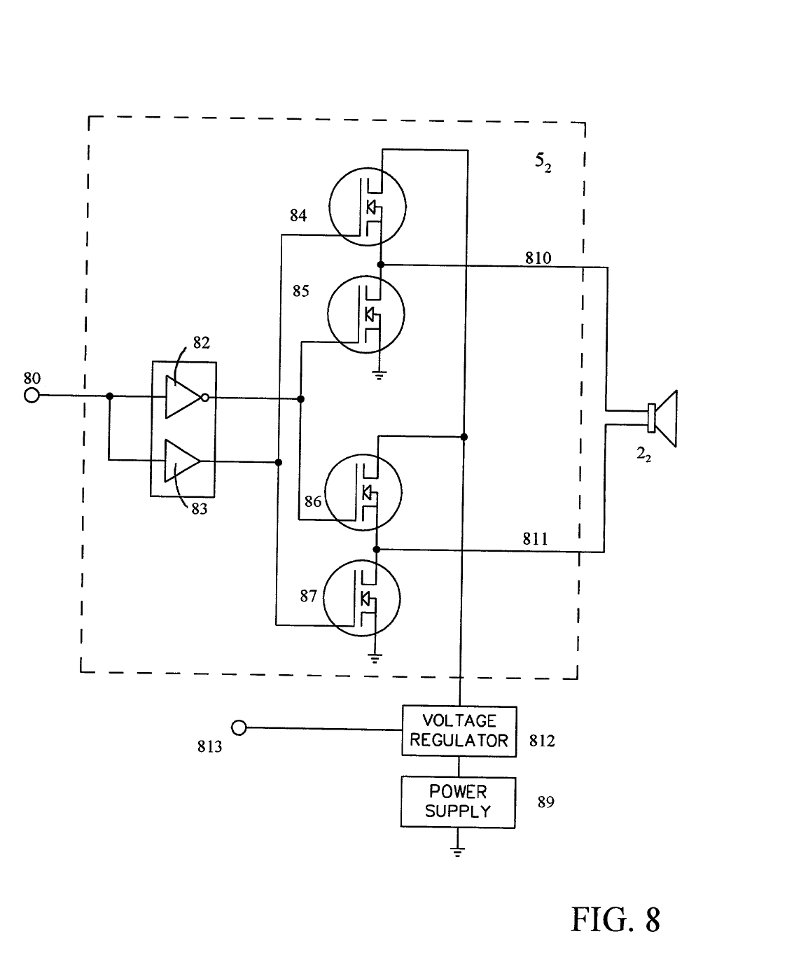

FIG. 8 is an illustrative schematic diagram of a digital driver e.g., 5₂ (see FIG. 2) of the present invention, shown in block form. A properly delayed (as determined by the methodology described supra) version of the digital bit stream is input at 80 and thus at inverting driver 82 and non-inverting driver 83. When the bit stream is at digital one, inverting driver 82 turns MOSFET switches 85 and 86 off while non-inverting driver 83 turns MOSFET switches 84 and 87 on. When the bit stream is at digital zero, the opposite takes place and MOSFET switches 85 and 86 are turned on while switches 84 and 87 are turned off.

The switches are connected to the sound producing element e.g., 2₂ (FIG. 2) by wires 810 and 811. When switches 85 and 86 are on, positive voltage from power supply 89 is applied through voltage regulator 812 and switch 86 to wire 811 and negative voltage (ground in this case) is applied by switch 85 to wire 810. When switches 84 and 87 are on, the opposite occurs and the voltage to the sound-producing element is reversed.

In the illustrative example of FIG. 8, the sound-producing element is shown as an ordinary cone type loudspeaker 2₂. When a digital one is input to the driver, the cone is caused to move outward by a small increment. Similarly a zero moves the cone inward by the same small increment. A long sequence of ones will drive the cone progressively outward, a string of zeros, progressively inward. Thus the motion of the cone follows the original analog audio signal without need for a D/A converter and audible sound is produced in the air.

Voltage regulator 812 can be used as a volume control if desired. A control signal applied at 813 causes the voltage regulator 812 to lower or raise the voltage applied by power supply 89. This causes the incremental movements of the loudspeaker cone to be smaller or larger and the audible signal from the cone to be softer or louder.

In the illustrative embodiment, there is only one voltage regulator and power supply for the entire array. Typical adjustable voltage regulators are set by establishing a voltage ratio on input pins with either a potentiometer (e.g., rotary or slide) or with fixed resistors. If a potentiometer is used, it can be configured to appear as an ordinary rotary or slide volume control. With appropriate control circuitry, the regulator can also be computer—controlled.

Any type of sound producing elements can be employed in implementations of the present invention. For example, while an ordinary driven cone type loudspeaker is depicted in the illustrative schematic of FIG. 8, piezo-electrically excited film membranes, electrostatically driven film membranes, vibrationally driven panels, or any other transducer capable of converting electrical energy to mechanical energy at audible frequencies can be equally used.

In the illustrative embodiments described herein, the arrays have been depicted as being flat. While this is likely the most common application, the array can also be curved or non-flat, for example to be used in conjunction with a vaulted or arched ceiling. Such an arched or non-flat deployment of the array will have an inherent fixed focus of its own. This focus, however is often beyond the close range target area in which this invention is operable and is none-the less fixed. To manipulate the focus of such an array would require physical re-orientation of the individual sound producing elements to re-direct the focus. Under the teachings of the present invention, the focus or target area is infinitely adjustable without any physical manipulation of the individual elements.

As previously pointed out and as will be appreciated by one of skill in the art, the sound producing elements in the various illustrative arrays are shown with a symmetrical rectangular distribution. The teachings of the present invention are equally applicable to any distribution of sound producing elements, of any geometry or symmetry.

It will be readily apparent that the present invention will have applications beyond those described herein. For example, the present invention can be adapted for use in any environment where precisely focused sound transmission is desired by implementing the principals taught herein.

The present invention has been illustrated and described with respect to specific embodiments and applications thereof. To facilitate discussion of the present invention, a preferred embodiment is assumed, however, the above-described embodiments are merely illustrative of the principals of the invention and are not intended to be exclusive embodiments thereof. It should be understood by one skilled in the art that alternative embodiments drawn to variations in the enumerated embodiments and teachings disclosed herein can be derived and implemented to realize the various benefits of the present invention.

It should further be understood that the foregoing and many various modifications, omissions and additions may be devised by one skilled in the art without departing from the spirit and scope of the invention. It is therefore intended that the present invention is not limited to the disclosed embodiments but should be defined in accordance with the claims which follow.

We claim:

1. A sound system with digitally controlled directivity comprising:
an array comprising at least two sound producing elements;
a digital control circuit responsive to a serial digital bit stream that controls the directivity of the array so that the sound produced by each said element arrives coincidentally at a predetermined target area.

2. The system of claim 1 further comprising a delta modulation converter to produce the serial digital bit stream wherein the digital control circuit is responsive to the serial digital bit stream.

3. The system of claim 2, wherein the digital control circuit comprises at least one digital time delay component and at least one digital driver component.

4. The system of claim 3, wherein each sound producing element is digitally controlled by its own delay and driver component.

5. The system of claim 3, wherein a plurality of sound producing elements are digitally controlled by the same delay and driver component.

6. The system of claim 3, wherein the digital time delay component is implemented by shift registers.

7. The system of claim 3, wherein the sound system further comprises a voltage regulator and power supply wherein said voltage regulator is utilized as a volume control by increasing or decreasing the voltage supplied by the power supply.

8. The system of claim 1 wherein the sound producing elements are arranged in a symmetrical configuration.

9. The system of claim 1 wherein the sound producing elements are arranged in an asymmetrical configuration.

10. The system of claim 1 wherein the sound producing elements are driven cone type loudspeaker.

11. The system of claim 1 wherein the sound producing elements are vibrationally driven panels.

12. A digital driver comprising:
a driver circuit responsive to a serial digital bit stream to digitally drive a sound producing element.

13. The driver of claim 12, wherein a delta modulation converter converts an audio signal into the serial digital bit stream.

14. The driver of claim 12, wherein a pulse width modulation converter converts an audio signal into the serial digital bit stream.

15. The driver of claim 12, wherein the sound producing element moves inward in response to digital bit stream of zeros and outward to digital bit stream of non-zeros.

16. The driver of claim 12, wherein each said digital driver comprises:
an inverting and a non-inverting driver; and
a plurality of MOSFET switches.

17. The driver of claim 12 where the driver is in communication with a voltage regulator, and a power supply and the voltage regulator is utilized as a volume control by increasing or decreasing the voltage supplied by the power supply.

18. The driver of claim 12 wherein the converted bit stream is digitally delayed prior to driving the sound producing element.

19. The driver of claim 12 wherein the sound producing element is a driven cone type loudspeaker.

20. The driver of claim 12 wherein the sound producing element is a vibrationally driven panel.
